(19) United States
(12) Patent Application Publication
(10) Pub. No.: US 2026/0142562 A1
(43) Pub. Date: May 21, 2026

(54) POWER SUPPLY CONTROL DEVICE

(71) Applicant: ROHM Co., LTD., Kyoto (JP)

(72) Inventor: Shidong Guan, Kyoto (JP)

(73) Assignee: ROHM Co., LTD., Kyoto (JP)

(21) Appl. No.: 19/301,024

(22) Filed: Aug. 15, 2025

(30) Foreign Application Priority Data
Aug. 22, 2024 (JP) 2024-140814

(51) Int. Cl. H02M 1/32; H02M 3/158

(52) U.S. Cl. CPC H02M 1/327; H02M 3/158

(57) ABSTRACT

Provided is a power supply control device provided in a switching power supply apparatus configured to convert an input voltage into an output voltage through switching of an output transistor, the power supply control device including a switching control circuit configured to stabilize the output voltage by performing switching control of the output transistor, based on a feedback voltage corresponding to the output voltage, and a temperature detecting circuit configured to detect a target temperature within the power supply control device and output a signal indicating a result of the detection of the target temperature to the switching control circuit, the switching control circuit being configured to be capable of performing an overcurrent protecting operation that limits a current flowing through the output transistor to a limit current or less, and the switching control circuit adjusting the limit current according to the target temperature.

### BACKGROUND

The present disclosure relates to a power supply control device.

A switching power supply apparatus that generates an output voltage from an input voltage is widely used. The switching power supply apparatus is provided with a power supply control device (power supply integrated circuit (IC)) for controlling the operation of the switching power supply apparatus. PCT Patent Publication No. WO2021/166389 described below is cited as an example of a document that discloses the power supply control device.

### BRIEF DESCRIPTION OF THE DRAWINGS

FIG. 1 is a general configuration diagram of a power supply device according to an embodiment of the present disclosure;

FIG. 2 is an external perspective view of a power supply control device according to the embodiment of the present disclosure;

FIG. 3 is a timing diagram in a normal operation period according to the embodiment of the present disclosure;

FIG. 4 is a diagram of assistance in explaining an overcurrent protecting operation according to the embodiment of the present disclosure;

FIG. 5 relates to the embodiment of the present disclosure and is an internal configuration diagram of a temperature detecting circuit;

FIG. 6 relates to the embodiment of the present disclosure and is a timing diagram of assistance in explaining operation of the temperature detecting circuit;

FIG. 7 relates to the embodiment of the present disclosure and is a diagram illustrating a relation between the output signal of the temperature detecting circuit and a limit current in the overcurrent protecting operation;

FIG. 8 relates to the embodiment of the present disclosure and is a timing diagram illustrating a relation between the output signal of the temperature detecting circuit and the limit current in the overcurrent protecting operation;

FIG. 9 relates to the embodiment of the present disclosure and is a circuit diagram of a protection level setting circuit;

FIG. 10 is a reference timing diagram of a reference power supply device;

FIG. 11 is a timing diagram of the power supply device according to the embodiment of the present disclosure;

FIG. 12 relates to the embodiment of the present disclosure and is a configuration diagram of an internal linear regulator;

FIG. 13 relates to the embodiment of the present disclosure and is a diagram illustrating a relation between the output signal of the temperature detecting circuit and an upper limit current in the internal linear regulator; and

FIG. 14 relates to a third example belonging to the embodiment of the disclosure and is a modified partial configuration diagram of the power supply device.

### DETAILED DESCRIPTION

Examples of an embodiment of the present disclosure will hereinafter specifically be described with reference to figures. In the figures to be referred to, identical parts are identified by the same reference numerals, and repeated description of the identical parts will be omitted in principle. Incidentally, in the present specification, for the simplification of description, the names of information, signals, physical quantities, functional units, circuits, elements, parts, or other relevant items corresponding to symbols or reference numerals may be omitted or abbreviated by writing the symbols or the reference numerals that refer to the information, the signals, the physical quantities, the functional units, the circuits, the elements, the parts, or the other relevant items.

First, a description will be provided for several terms used in describing embodiments of the present disclosure. A ground refers to a reference conductive portion (reference conductor) having a potential (electric potential) of 0 V (zero volts) serving as a reference, or refers to the potential of 0 V itself. The reference conductive portion may be formed using a conductor of metal, for example. The potential of 0 V is sometimes referred to as a ground potential. In the embodiments of the present disclosure, a voltage illustrated without being particularly provided with a reference represents a potential as viewed from the ground.

A level refers to the level (height) of a potential. A high level of any signal or voltage of interest has a potential higher than a low level. In any signal or voltage of interest, a rise edge refers to switching from a low level to a high level, and a fall edge refers to switching from a high level to a low level.

With regard to any transistor configured as a field effect transistor (FET) exemplified by a MOSFET, an on state refers to a state in which there is conduction between the drain and source of the transistor, and an off state refers to a state in which there is no conduction between the drain and source of the transistor (interrupted state). The same applies to transistors not classified as a FET. Unless otherwise specified, a MOSFET is construed as an enhancement type MOSFET. The MOSFET is an abbreviation of “metal-oxide-semiconductor field-effect transistor.” In addition, unless otherwise specified, in any MOSFET, a back gate may be regarded to be short-circuited to a source.

In the following, with regard to any transistor, an on state and an off state may be expressed simply as on and off. In addition, with regard to any transistor, a period in which the transistor is set in an on state will be referred to as an on period, and a period in which the transistor is set in an off state will be referred to as an off period.

With regard to any signal having a signal level of a high level or a low level, a period in which the level of the signal is set to be a high level will be referred to as a high level period, and a period in which the level of the signal is set to be a low level will be referred to as a low level period. The same applies to any voltage having a voltage level of a high level or a low level.

Unless otherwise specified, a connection between a plurality of parts forming a circuit, such as freely-selected circuit elements, wires, or nodes, may be construed as referring to an electric connection.

Supposing that two freely-selected voltages to be compared with each other are voltages v1 and v2, “v1>v2” denotes that the voltage v1 is higher than the voltage v2, “v1<v2” denotes that the voltage v1 is lower than the voltage v2, and “v1=v2” denotes that the value of the voltage v1 is the same as the value of the voltage v2. The same applies to other expressions including physical quantities other than voltages.

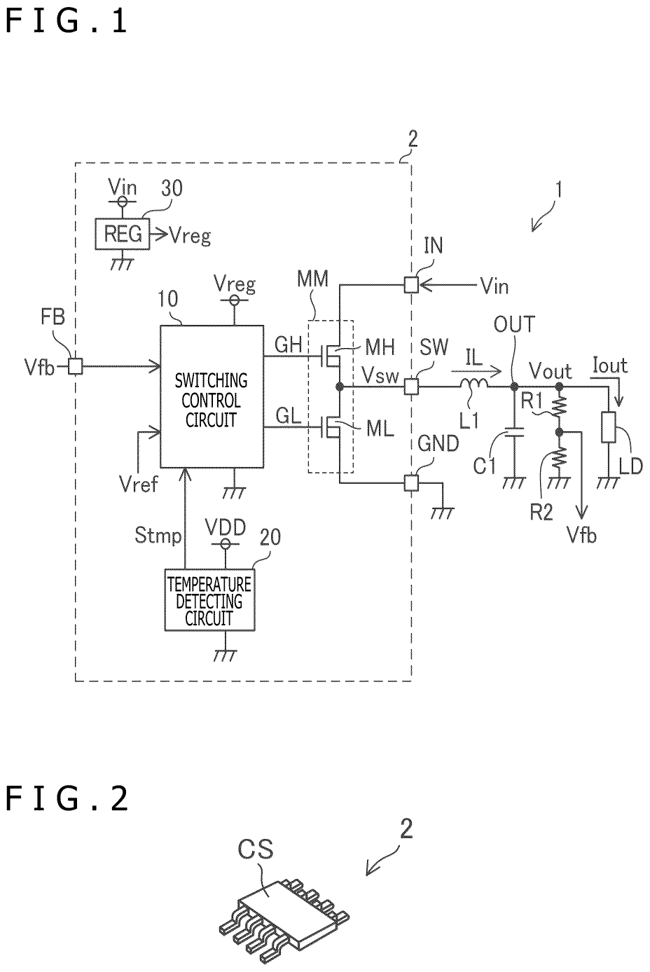

FIG. 1 is a general configuration diagram of a power supply device 1 according to an embodiment of the present disclosure. The power supply device 1 in FIG. 1 includes a power supply control device 2 for controlling operation of the power supply device 1, and also includes a coil L1, an output capacitor C1, and feedback resistances R1 and R2 as discrete parts provided outside the power supply control device 2. A load LD illustrated in FIG. 1 is not a constituent element of the power supply device 1, and is provided outside the power supply device 1.

FIG. 2 illustrates an external perspective view of the power supply control device 2. The power supply control device 2 is an electronic part (semiconductor device) including a semiconductor chip having a semiconductor integrated circuit formed on a semiconductor substrate, a casing CS (package) housing the semiconductor chip, and a plurality of external terminals exposed from the casing CS to the outside of the power supply control device 2. The power supply control device 2 is formed by sealing the semiconductor chip within the casing CS formed of resin. It is to be noted that the number of the external terminals of the power supply control device 2 illustrated in FIG. 2 and the type of the casing CS of the power supply control device 2 are merely illustrative, and these can be designed as desired.

The power supply device 1 in FIG. 1 is configured as a step-down switching power supply apparatus (direct-current/direct-current (DC/DC) converter) that generates a desired output voltage Vout from an input voltage Vin supplied from a direct-current voltage source not illustrated. The output voltage Vout occurs at an output terminal OUT. That is, the output terminal OUT is an application terminal of the output voltage Vout (terminal to which the output voltage Vout is applied). The output voltage Vout is supplied to the load LD connected to the output terminal OUT. Except for a transient state, the input voltage Vin and the output voltage Vout are positive direct-current voltages, and the output voltage Vout is lower than the input voltage Vin. When the input voltage Vin is 12 V, for example, the output voltage Vout can be stabilized at a desired positive voltage value (for example, 3.3 V or 5 V) less than 12 V by adjusting the resistance values of the feedback resistances R1 and R2. A current supplied from the output terminal OUT to the load LD will be referred to as a load current Iout. The load current Iout is an output current of the power supply device 1. It is to be noted that the power supply device 1 may be a switching power supply apparatus other than the step-down type, and may be configured as, for example, a step-up or step-up/down switching power supply apparatus.

FIG. 1 illustrates an input terminal IN, a switch terminal SW, a ground terminal GND, and a feedback terminal FB as a part of a group of external terminals provided to the power supply control device 2. Other external terminals (for example, a power-good terminal, an enable terminal, and other terminals) can also be provided to the power supply control device 2.

An external configuration of the power supply control device 2 will be described. The input voltage Vin is supplied to the input terminal IN from the direct-current voltage source (not illustrated) provided outside the power supply control device 2. The coil L1 is interposed in series between the switch terminal SW and the output terminal OUT. That is, a first end of the coil L1 is connected to the switch terminal SW, and a second end of the coil L1 is connected to the output terminal OUT. In addition, the output terminal OUT is connected to a ground via the output capacitor C1. That is, a first end of the output capacitor C1 is connected to the output terminal OUT, and a second end of the output capacitor C1 is connected to the ground. Further, the output terminal OUT is connected to a first end of the feedback resistance R1, a second end of the feedback resistance R1 is connected to a first end of the feedback resistance R2, and a second end of the feedback resistance R2 is connected to the ground. A feedback voltage Vfb occurs at a connection node between the feedback resistances R1 and R2. The connection node between the feedback resistances R1 and R2 is connected to the feedback terminal FB. The feedback voltage Vfb is thereby input to the feedback terminal FB. The ground terminal GND is connected to the ground. A current flowing through the coil L1 will be referred to as a coil current IL. The coil current IL in a direction from the switch terminal SW to the output terminal OUT has a positive polarity.

An internal configuration of the power supply control device 2 will be described. The power supply control device 2 includes an output stage circuit MM, a switching control circuit 10, a temperature detecting circuit 20, and an internal power supply circuit 30. Besides, circuits for implementing various functions (a low voltage protection circuit, an overvoltage protection circuit, and a reverse current protection circuit, and other circuits) are provided to the power supply control device 2. However, in the following, attention will be directed to the circuits MM, 10, 20, and 30.

The output stage circuit MM includes transistors MH and ML. In the configuration example of FIG. 1, the transistors MH and ML are constituted by an N-channel MOSFET. The transistors MH and ML are a pair of switching elements serially connected between the input terminal IN and the ground terminal GND (in other words, the ground). The transistor MH functions as an output element (output transistor), and the transistor ML functions as a rectifying element (synchronous rectifier transistor). The transistor MH is provided on a higher potential side than the transistor ML. Specifically, a drain of the transistor MH is connected to the input terminal IN as an application terminal of the input voltage Vin, and is supplied with the input voltage Vin. A source of the transistor MH and a drain of the transistor ML are connected in common to the switch terminal SW. A source of the transistor ML is connected to the ground terminal GND (therefore connected to the ground). However, a resistance for current detection may be inserted between the source of the transistor ML and the ground terminal GND.

The switching control circuit 10 switching-controls the output stage circuit MM. The switching control of the output stage circuit MM switches the transistors MH and ML to alternately turn on and off the transistors MH and ML. The switching control of the output stage circuit MM causes a switch voltage Vsw in a rectangular wave shape to appear at the switch terminal SW. The coil L1 and the output capacitor C1 constitute a rectifying and smoothing circuit that generates the output voltage Vout by rectifying and smoothing the switch voltage Vsw in a rectangular wave shape that appears at the switch terminal SW. The feedback resistances R1 and R2 constitute a feedback voltage generating circuit that generates the feedback voltage Vfb corresponding to the output voltage Vout by voltage-dividing the output voltage Vout. The feedback voltage Vfb is proportional to the output voltage Vout. As the output voltage Vout rises or falls, the feedback voltage Vfb also rises or falls.

Incidentally, a modification may be made such that the output voltage Vout itself is used as the feedback voltage Vfb. In either case, the feedback voltage Vfb is a voltage corresponding to the output voltage Vout. In addition, the feedback voltage generating circuit (R1 and R2) may be provided within the power supply control device 2. In this case, the feedback terminal FB is connected to the output terminal OUT.

Gates of the transistors MH and ML are respectively supplied with gate signals GH and GL as driving signals from the switching control circuit 10. The transistors MH and ML are turned on and off according to the gate signals GH and GL. The transistor MH is in an on state during a high level period of the gate signal GH, and the transistor MH is in an off state during a low level period of the gate signal GH. Similarly, the transistor ML is in an on state during a high level period of the gate signal GL, and the transistor ML is in an off state during a low level period of the gate signal GL.

Basically, the transistors MH and ML are alternately turned on and off. However, the transistors MH and ML may both be maintained in an off state. That is, the state of the output stage circuit MM is one of an output high state, an output low state, and a double off state. In the output high state, the transistor MH is in an on state, and the transistor ML is in an off state. In the output low state, the transistor MH is in an off state, and the transistor ML is in an on state. In the double off state, the transistors MH and ML are both in an off state. The transistors MH and ML are not simultaneously set in an on state. In the switching control by the switching control circuit 10, alternately turning on and off the transistors MH and ML is a concept including the intervention of the double off state with a dead time or other factor taken into consideration during a transition between the output low state and the output high state. Incidentally, at least one of the transistors MH and ML may be provided outside the power supply control device 2. The whole of the output stage circuit MM may be provided outside the power supply control device 2 and connected to the power supply control device 2.

The switching control circuit 10 is connected to the feedback terminal FB and receives the feedback voltage Vfb. The switching control circuit 10 controls the respective on/off states of the transistors MH and ML through level control on the gate signals GH and GL based on the feedback voltage Vfb. The switching control circuit 10 thereby makes a desired output voltage Vout generated at the output terminal OUT. A reference voltage Vref having a predetermined positive direct-current voltage value is generated within the power supply control device 2. The switching control circuit 10 performs switching control of the output stage circuit MM such that the feedback voltage Vfb coincides with the reference voltage Vref. When the feedback voltage Vfb coincides with the reference voltage Vref, the output voltage Vout coincides with a predetermined target voltage Vtg. That is, the switching control circuit 10 performs switching control of the output stage circuit MM, based on the feedback voltage Vfb, to stabilize the output voltage Vout at the target voltage Vtg (to reduce a difference between the output voltage Vout and the target voltage Vtg).

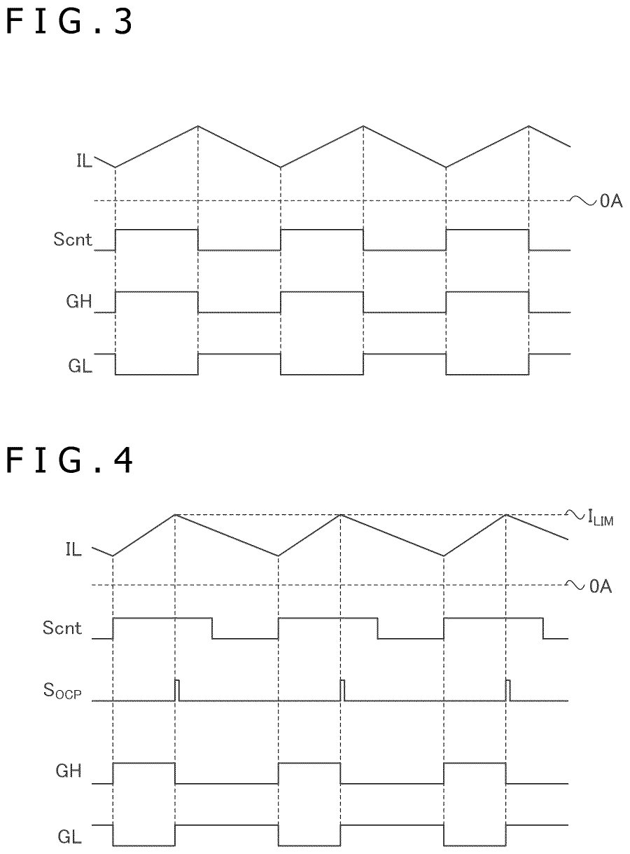

Switching control in a normal operation period will be described with reference to FIG. 3. In the normal operation period, the switching control is performed in a state in which an overcurrent protecting operation to be described later is not performed. Incidentally, at a light load (when the load current Iout is fairly small), a timing at which the coil current IL becomes negative can occur. However, here, the power supply device 1 is assumed to operate in a continuous mode in which the coil current IL has a positive value at all times. In a period in which the output stage circuit MM is in the output high state, the coil current IL flows through the drain and source of the transistor MH. The coil current IL in the on period of the transistor MH is therefore equal to the drain current of the transistor MH. In a period in which the output stage circuit MM is in the output low state, the coil current IL flows through the drain and source of the transistor ML.

The coil current IL gradually increases in a period in which the output stage circuit MM is in the output high state (that is, an on period of the transistor MH). The coil current IL gradually decreases in a period in which the output stage circuit MM is in the output low state (that is, an on period of the transistor ML).

The switching control circuit 10 generates a switching control signal Scnt, based on the feedback voltage Vref. The switching control circuit 10 may generate the switching control signal Scnt, based on the feedback voltage Vref and the coil current IL. Here, suppose that the switching control signal Scnt is a single binary signal that has a low level or a high level. However, the switching control signal Scnt may be formed by a combination of a set signal and a reset signal that are each a binary signal. The switching control signal Scnt alternately has a low level and a high level. The switching control signal Scnt having a high level is a signal commanding the state of the output stage circuit MM to be set to the output high state. The switching control signal Scnt having a low level is a signal commanding the state of the output stage circuit MM to be set to the output low state. In the normal operation period, the switching control circuit 10 performs the switching control according to the switching control signal Scnt. Hence, the switching control circuit 10 in the normal operation period sets the output stage circuit MM to the output high state by setting the gate signal GH to a high level and setting the gate signal GL to a low level in a high level period of the switching control signal Scnt. The switching control circuit 10 in the normal operation period sets the output stage circuit MM to the output low state by setting the gate signal GH to a low level and setting the gate signal GL to a high level in a low level period of the switching control signal Scnt.

The switching control circuit 10 generates the switching control signal Scnt in such a manner as to increase the output duty of the output stage circuit MM when “Vfb<Vref” or conversely decrease the output duty of the output stage circuit MM when “Vfb>Vref” (for example, adjusts the width of the high level period of the switching control signal Scnt or the width of the low level period thereof). An error between the feedback voltage Vfb and the reference voltage Vref is thereby maintained in the vicinity of zero. As a result, the output voltage Vout is stabilized at the target voltage Vtg. The output duty of the output stage circuit MM is a ratio of an on period of the transistor MH to a sum of the on period of the transistor MH and an off period of the transistor MH.

A control system for stabilizing the output voltage Vout at the target voltage Vtg may be selected as desired. A pulse width modulation system may be adopted in the control system for stabilizing the output voltage Vout at the target voltage Vtg. In a case where the pulse width modulation system is adopted, the switching frequency of the output stage circuit MM (in other words, the frequency of the switching control signal Scnt) is fixed, and then the width of the high level period of the switching control signal Scnt is adjusted in such a manner as to reduce the error between the feedback voltage Vfb and the reference voltage Vref. A constant on-time control system may be adopted in the control system for stabilizing the output voltage Vout at the target voltage Vtg. In a case where the constant on-time control system is adopted, the width of the high level period of the switching control signal Scnt is fixed, and then the width of the low level period of the switching control signal Scnt is adjusted in such a manner as to reduce the error between the feedback voltage Vfb and the reference voltage Vref. A pulse frequency modulation system may be adopted in the control system for stabilizing the output voltage Vout at the target voltage Vtg.

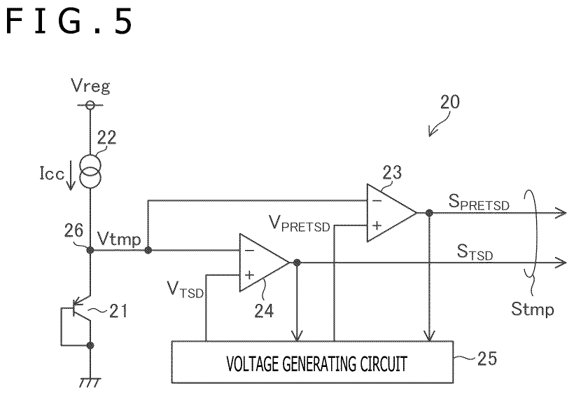

The switching control circuit 10 is capable of performing an overcurrent protecting operation. The overcurrent protecting operation will be described with reference to FIG. 4. As described above, the coil current IL gradually increases in a period in which the output stage circuit MM is in the output high state (that is, an on period of the transistor MH), and the coil current IL gradually decreases in a period in which the output stage circuit MM is in the output low state (that is, an on period of the transistor ML). The overcurrent protecting operation limits the coil current IL (hence, the drain current of the transistor MH in the on period of the transistor MH) to a limit current I_{LIM} or less. The switching control circuit 10 in the overcurrent protecting operation detects the magnitude of the coil current IL in the on period of the transistor MH, and monitors whether or not the coil current IL in the on period of the transistor MH (hence, the drain current of the transistor MH) reaches the limit current I_{LIM}. The switching control circuit 10 generates an overcurrent protection signal S_{OCP} as a signal indicating a result of the monitoring. The limit current I_{LIM} has a positive current value.

A method of detecting the coil current IL may be selected as desired. For example, in the on period of the transistor MH, the switching control circuit 10 can detect the coil current IL, based on an on resistance of the transistor MH known to the power supply control device 2 and a drain-to-source voltage of the transistor MH. Alternatively, for example, in the on period of the transistor MH, the coil current IL may be detected through detection of a current flowing through a replica transistor connected in parallel with the transistor MH. Alternatively, for example, a shunt resistance (not illustrated) may be connected in series with the transistor MH in advance, and the coil current IL may be detected based on a voltage drop across the shunt resistance.

The overcurrent protection signal S_{OCP} is a binary signal having a high level or a low level. The switching control circuit 10 sets the overcurrent protection signal S_{OCP} to a low level in principle, and sets the overcurrent protection signal S_{OCP} to a high level for a minute time when the coil current IL (hence, the drain current of the transistor MH) reaches the limit current I_{LIM} in the on period of the transistor MH. The switching control circuit 10 may provide the overcurrent protection signal S_{OCP} with a high level for a period in which the coil current IL is equal to or more than the limit current I_{LIM}. When a rise edge occurs in the overcurrent protection signal S_{OCP} after the switching control circuit 10 sets the output stage circuit MM to the output high state with a rise edge in the switching control signal Scnt as a trigger, the switching control circuit 10 immediately switches the output stage circuit MM from the output high state to the output low state without waiting for the occurrence of a fall edge in the switching control signal Scnt (that is, irrespective of the switching control signal Scnt). When the next rise edge in the switching control signal Scnt thereafter occurs, the switching control circuit 10 sets the output stage circuit MM to the output high state again. Such an overcurrent protecting operation limits the coil current IL (hence, the drain current of the transistor MH) to the limit current I_{LIM} or less.

The temperature detecting circuit 20 detects a temperature at a measurement target position, and generates a temperature detection signal Stmp corresponding to the temperature at the measurement target position (detected temperature at the measurement target position). The temperature detection signal Stmp is input to the switching control circuit 10. The temperature at the measurement target position will be referred to as a target temperature TMP. The temperature detecting circuit 20 is provided with a temperature measuring element (not illustrated) for detecting the target temperature TMP. The temperature measuring element is disposed at the measurement target position, and outputs a signal corresponding to the target temperature TMP in cooperation with a circuit connected to the temperature measuring element. For example, the temperature measuring element is installed at a position suitable for measuring the temperature of the transistor MH or ML. At this time, the temperature measuring element is disposed at a position in proximity to the transistor MH or ML. Electrical characteristics of the temperature measuring element change according to the target temperature TMP. A silicon diode can be used as the temperature measuring element. The target temperature TMP can be detected using the temperature characteristics of a forward voltage of the diode. The target temperature TMP may be detected using a base-to-emitter voltage of a bipolar transistor in place of the forward voltage of the diode.

The internal power supply circuit 30 is connected to the input terminal IN and the ground terminal GND, and generates an internal power supply voltage Vreg, based on the input voltage Vin. The internal power supply voltage Vreg is a direct-current voltage lower than the input voltage Vin. The circuits (including the switching control circuit 10 and the temperature detecting circuit 20) within the power supply control device 2 are driven based on the internal power supply voltage Vreg.

Incidentally, whereas the gate signal GL is a signal having a ground potential as a reference, the gate signal GH is a signal having the potential of the switch terminal SW as a reference. The gate signal GH at a low level has the potential of the switch terminal SW. The gate signal GH at a high level is higher by a predetermined voltage as viewed from the potential of the switch terminal SW. The predetermined voltage here is higher than a gate threshold voltage of the transistor MH. A boosting power supply for generating the gate signal GH can be created using a well-known bootstrap circuit (not illustrated). The transistor MH may be constituted by a P-channel MOSFET. In that case, the boosting power supply is unnecessary.

In addition, as a modification, a diode rectification system may be adopted in the power supply device 1. In this case, as the rectifying element, a synchronous rectifier diode having an anode connected to the ground terminal GND and a cathode connected to the switch terminal SW is provided to the power supply device 1 in place of the transistor ML. In this case, only the transistor MH is turned on and off in the switching control of the output stage circuit MM. In either case, the input voltage Vin is converted into the output voltage Vout through the switching of the transistor MH (output transistor) between on and off in the switching control of the output stage circuit MM.

FIG. 5 illustrates an internal configuration of the temperature detecting circuit 20. The temperature detecting circuit 20 includes a transistor 21, a constant-current source 22, comparators 23 and 24, and a voltage generating circuit 25. The transistor 21 is a PNP bipolar transistor.

A base and a collector of the transistor 21 are short-circuited to each other and connected to a ground. An emitter of the transistor 21 is connected to a node 26. The constant-current source 22 operates based on the internal power supply voltage Vreg, and supplies a constant current Icc from an application terminal of the internal power supply voltage Vreg to the node 26. The constant current Icc flows to the ground through the transistor 21. A voltage at the node 26 will be referred to as a voltage Vtmp. The voltage Vtmp is a base-to−emitter voltage of the transistor 21 at a time when the constant current Icc flows as an emitter current of the transistor 21. The transistor 21 functions as the above-described temperature measuring element, and is disposed at the measurement target position. The temperature of the transistor 21 is hence equal to the target temperature TMP. Due to the temperature characteristics of the transistor 21, the voltage Vtmp falls as the target temperature TMP becomes higher, and the voltage Vtmp rises as the target temperature TMP becomes lower.

The comparators 23 and 24 operate based on the internal power supply voltage Vreg. The comparators 23 and 24 each have an inverting input terminal, a non-inverting input terminal, and an output terminal. The respective inverting input terminals of the comparators 23 and 24 are connected to the node 26, and receive the voltage Vtmp. The non-inverting input terminal of the comparator 23 is supplied with a voltage V_{PRETSD}. The non-inverting input terminal of the comparator 24 is supplied with a voltage V_{TSD}.

The comparator 23 compares the voltage Vtmp with the voltage V_{PRETSD}, and outputs a signal S_{PRETSD} corresponding to the level relation between the voltages Vtmp and V_{PRETSD} from the output terminal of the comparator 23 itself. The signal S_{PRETSD} has a high level in a period in which “Vtmp<V_{PRETSD}” holds and has a low level in a period in which “Vtmp>V_{PRETSD}” holds. The signal S_{PRETSD} has a high level or a low level when “Vtmp=V_{PRETSD}” holds. The comparator 24 compares the voltage Vtmp with the voltage V_{TSD}, and outputs a signal S_{TSD} corresponding to the level relation between the voltages Vtmp and V_{TSD} from the output terminal of the comparator 24 itself. The signal S_{TSD} has a high level in a period in which “Vtmp<V_{TSD}” holds and has a low level in a period in which “Vtmp>V_{TSD}” holds. The signal S_{TSD} has a high level or a low level when “Vtmp=V_{TSD}” holds. The temperature detection signal Stmp includes the signals S_{PRETSD} and S_{TSD}. The signals S_{PRETSD} and S_{TSD} are therefore input to the switching control circuit 10. The signals S_{PRETSD} and S_{TSD} are input also to the voltage generating circuit 25.

The voltage generating circuit 25 operates based on the internal power supply voltage Vreg, supplies the voltage V_{PRETSD} to the non-inverting input terminal of the comparator 23, and supplies the voltage V_{TSD} to the non-inverting input terminal of the comparator 24. The voltage generating circuit 25 can generate the voltages V_{PRETSD} and V_{TSD} by voltage-dividing the internal power supply voltage Vreg with use of a ladder resistance. The voltage generating circuit 25 adjusts the voltages V_{PRETSD} and V_{TSD} such that hysteresis characteristics are imparted in the comparison of the comparators 23 and 24.

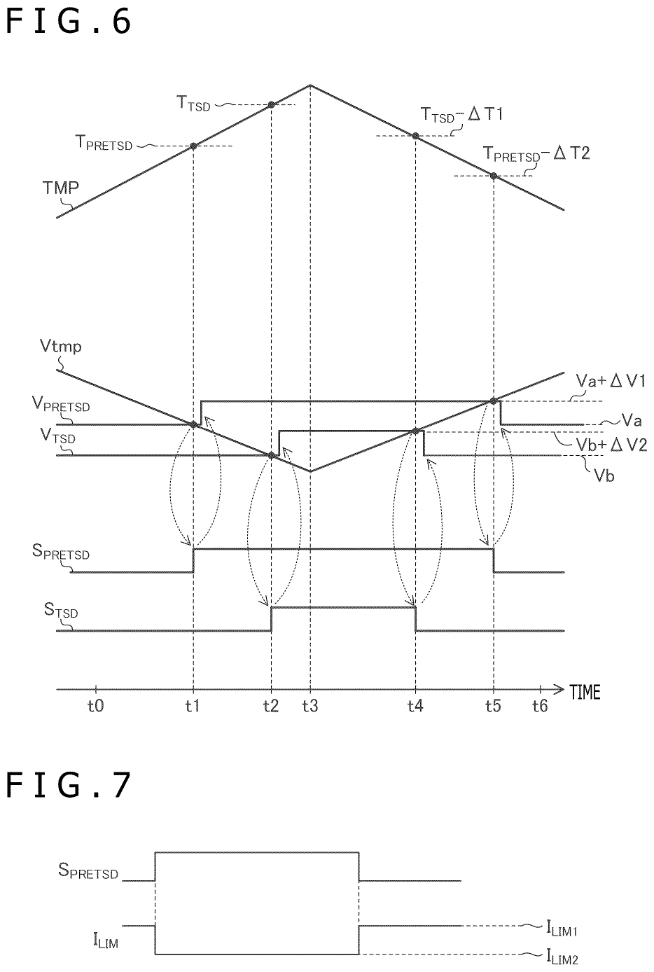

With reference to FIG. 6, a description will be made of operation of the temperature detecting circuit 20, including a description of the hysteresis characteristics. The voltage generating circuit 25 sets a voltage Va or a voltage (Va+ΔV1) for the voltage V_{PRETSD}. The voltage (Va+ΔV1) is higher than the voltage Va by a voltage ΔV1. The voltage ΔV1 is a hysteresis width provided in the comparison of the comparator 23. The voltage ΔV1 has a predetermined positive voltage value. The voltage generating circuit 25 sets a voltage Vb or a voltage (Vb+ΔV2) for the voltage V_{TSD}. The voltage (Vb+ΔV2) is higher than the voltage Vb by a voltage ΔV2. The voltage ΔV2 is a hysteresis width provided in the comparison of the comparator 24. The voltage ΔV2 has a predetermined positive voltage value. The voltage Va is higher than the voltage Vb. FIG. 6 illustrates a state in which “Va>Vb+ΔV2” holds. However, with regard to the voltage Va and the voltage (Vb+ΔV2), any of “Va>Vb+ΔV2,” “Va=Vb+ΔV2,” and “Va<Vb+ΔV2” may hold. However, in any case, the voltage (Va+ΔV1) is higher than the voltage (Vb+ΔV2). Typically, for example, the following may hold: “Vb<Vb+ΔV2=Va<Va+ΔV1.”

The respective values of the voltages Va, Vb, ΔV1, and ΔV2 are designed such that the voltage Vtmp coincides with the voltage Va when the target temperature TMP coincides with a predetermined threshold temperature T_{PRETSD}, such that the voltage Vtmp coincides with the voltage Vb when the target temperature TMP coincides with a predetermined threshold temperature T_{TSD}, such that the voltage Vtmp coincides with the voltage (Vb+ΔV2) when the target temperature TMP coincides with a predetermined threshold temperature (T_{TS}_{^{D}}−ΔT1), and such that the voltage Vtmp coincides with the voltage (Va+ΔV1) when the target temperature TMP coincides with a predetermined threshold temperature (T_{PRETSD}−ΔT2).

The threshold temperature T_{TSD} is higher than the threshold temperature T_{PRETSD}. The threshold temperature (T_{PRETSD}−ΔT2) is lower than the threshold temperature T_{PRETSD} by a temperature ΔT2. The temperature ΔT2 is a temperature converted value of a hysteresis width provided in the comparison of the comparator 23, and has a predetermined positive value with temperature as a unit. The threshold temperature (T_{TSD}−ΔT1) is lower than the threshold temperature T_{TSD} by a temperature ΔT1. The temperature ΔT1 is a temperature converted value of a hysteresis width provided in the comparison of the comparator 24, and has a predetermined positive value with temperature as a unit. With regard to the threshold temperature T_{PRETSD} and the threshold temperature (T_{TSD} −ΔT1), any of the following may hold: “T_{PRETSD}>T_{TSD}−ΔT1,” “T_{PRETSD}=T_{TSD}−ΔT1,” and “T_{PRETSD}<T_{TSD}−ΔT1.” However, in any case, the threshold temperature (T_{TSD}−ΔT1) is higher than the threshold temperature (T_{PRETSD}−ΔT2). Typically, for example, the following may hold: “T_{PRETSD}−ΔT2<T_{PRETSD}=T_{TSD}−ΔT1<T_{TSD}.” As a specific numerical value example, the threshold temperatures T_{TSD} and T_{PRETSD} can be set at 175° C. and 150° C., respectively, and the temperatures ΔT1 and T2 can be set at 25° C. Needless to say, the technology according to the present disclosure is not limited to the numerical value example.

Suppose that times t0, t1, t2, t3, t4, t5, and t6 arrive in this order with the progress of time. Suppose that the target temperature TMP monotonically rises from time t0 to time t3 and that the target temperature TMP monotonically falls from time t3 to time t6. Suppose that the power supply control device 2 is in an initial state at time t0 and before time t0. A state immediately after a start of the power supply control device 2 may be regarded as the initial state. In the initial state, the voltage generating circuit 25 sets the voltage Va for the voltage V_{PRETSD} and sets the voltage Vb for the voltage V_{TSD}. In the initial state, the target temperature TMP is lower than the threshold temperature (T_{PRETSD}−ΔT2). In the initial state, “Vtmp>Va=V_{PRETSD}” and “Vtmp>Vb=V_{TSD}” hold. The signals S_{PRETSD} and S_{TSD} therefore both have a low level.

In a rising process of the target temperature TMP in a period between times t0 and t3, switching from a state in which “TMP<T_{PRETSD}” holds to a state in which “TMP>T_{PRETSD}” holds occurs with time t1 as a boundary. Hence, switching from a state in which “Vtmp>Va” holds to a state in which “Vtmp<Va” holds occurs with time t1 as a boundary. A rise edge hence occurs in the signal S_{PRETSD} at time t1. The voltage generating circuit 25 switches the voltage V_{PRETSD} from the voltage Va to the voltage (Va+ΔV1) in response to the rise edge in the signal S_{PRETSD} at time t1.

The target temperature TMP thereafter further rises, so that switching from a state in which “TMP<T_{TSD}” holds to a state in which “TMP>T_{TSD}” holds occurs with time t2 as a boundary. Hence, switching from a state in which “Vtmp>Vb” holds to a state in which “Vtmp<Vb” holds occurs with time t2 as a boundary. A rise edge hence occurs in the signal S_{TSD} at time t2. The voltage generating circuit 25 switches the voltage V_{TSD} from the voltage Vb to the voltage (Vb+ΔV2) in response to the rise edge in the signal S_{TSD} at time t2. The changing direction of the temperature TMP is thereafter reversed from a rising direction to a falling direction with time t3 as a boundary.

In a falling process of the target temperature TMP in a period between times t3 and t6, switching from a state in which “TMP>T_{TSD}−ΔT1” holds to a state in which “TMP<T_{TSD}−ΔT1” holds occurs with time t4 as a boundary. Hence, switching from a state in which “Vtmp<Vb+ΔV2” holds to a state in which “Vtmp>Vb+ΔV2” holds occurs with time t4 as a boundary. A fall edge hence occurs in the signal S_{TSD} at time t4. The voltage generating circuit 25 switches the voltage V_{TSD} from the voltage (Vb+ΔV2) to the voltage Vb in response to the fall edge in the signal S_{TSD} at time t4.

The target temperature TMP thereafter further falls, so that switching from a state in which “TMP>T_{PRETSD}−ΔT2” holds to a state in which “TMP<T_{PRETSD}−ΔT2” holds occurs with time t5 as a boundary. Hence, switching from a state in which “Vtmp<Va+ΔV1” holds to a state in which “Vtmp>Va+ΔV1” holds occurs with time t5 as a boundary. A fall edge hence occurs in the signal S_{PRETSD} at time t5. The voltage generating circuit 25 switches the voltage V_{PRETSD} from the voltage (Va+ΔV1) to the voltage Va in response to the fall edge in the signal S_{PRETSD} at time t5.

In the rising process of the target temperature TMP in the period between times t0 and t3, the output signals (S_{PRETSD} and S_{TSD}) from the temperature detecting circuit 20 to the switching control circuit 10 indicate the level relation between the target temperature TMP and the threshold temperature T_{PRETSD} and the level relation between the target temperature TMP and the threshold temperature T_{TSD}. In the falling process of the target temperature TMP in the period between times t3 and t6, the output signals (S_{PRETSD} and S_{TSD}) from the temperature detecting circuit 20 to the switching control circuit 10 indicate the level relation between the target temperature TMP and the threshold temperature (T_{TSD}−ΔT1) and the level relation between the target temperature TMP and the threshold temperature (T_{PRETSD}−ΔT2).

When a rise edge has occurred in the signal S_{PRETSD} with the initial state as a starting point, a state in which the signal S_{PRETSD} has a high level and the signal S_{TSD} has a low level corresponds to a first temperature state in which the target temperature TMP is higher than the threshold temperature T_{PRETSD} but lower than the threshold temperature T_{TSD}. The switching of the signal S_{TSD} to a high level with the first temperature state as a starting point indicates that the target temperature TMP in a process of rising has reached the threshold temperature T_{TSD}. A state in which the signals S_{PRETSD} and S_{TSD} both have a high level after the switching of the signal S_{TSD} to a high level corresponds to a second temperature state in which the target temperature TMP is held higher than the threshold temperature (T_{TSD}−ΔT1) after rising beyond the threshold temperature T_{TSD}. The switching of the signal S_{TSD} to a low level with the second temperature state as a starting point indicates that the target temperature TMP has fallen below the threshold temperature (T_{TSD}−ΔT1). The switching of the signal S_{PRETSD} to a low level after the switching of the signal S_{TSD} to a low level with the second temperature state as a starting point indicates that the target temperature TMP has fallen below the threshold temperature (T_{PRETSD}−ΔT2).

The switching control circuit 10 performs a thermal shutdown operation (hereinafter referred to as a TSD operation) when the signal S_{TSD} has a high level. In the TSD operation, the switching control circuit 10 stops the switching control of the output stage circuit MM, and sets the output stage circuit MM in the double off state. A main factor in the rising of the target temperature TMP is a switching loss in the output stage circuit MM which accompanies the switching control. Hence, the target temperature TMP is expected to stop rising and fall due to the stopping of the switching control. Protection of the power supply control device 2 is therefore achieved. In recent years, an increase in the input voltage Vin has often been demanded. The increase in the input voltage Vin tends to lead to an increase in heat generation.

Although the stopping of the switching control by the TSD operation is important for protecting the power supply control device 2, the stopping of the switching control causes a sharp decrease in the output voltage Vout, which can adversely affect various kinds of subsequent stage circuits (including the load LD) that use the output voltage Vout. It is therefore preferable to avoid the execution of the TSD operation as much as possible. After a decrease in the output voltage Vout to 0 V, an increase in the output voltage Vout due to resumption of the switching control with a fall in the target temperature TMP and then a decrease in the output voltage Vout to 0 V again as a result of the TSD operation functioning again due to the resumption of the switching control, for example, may be repeated (operation of the system including the power supply device 1 becomes unstable). Meanwhile, the switching loss in the output stage circuit MM is increased particularly under conditions where the overcurrent protecting operation is exerted. Therefore, when the limit current I_{LIM} in the overcurrent protecting operation is decreased, the target temperature TMP does not rise easily, and the TSD operation is not readily performed. However, setting the limit current I_{LIM} low at all times leads to a decrease in a current supply capability of the power supply device 1.

With these circumstances taken into consideration, the switching control circuit 10 adjusts the limit current I_{LIM} according to the target temperature TMP (dynamically changes the limit current I_{LIM}). The switching control circuit 10 preferably decreases the limit current I_{LIM} stepwise as the target temperature TMP rises. This prevents the stopping of the switching control by the TSD operation from occurring easily.

FIG. 7 illustrates a relation between the signal S_{PRETSD} and the limit current I_{LIM}. Specifically, the switching control circuit 10 sets a current value I_{LIM1} for the limit current I_{LIM} (that is, makes the value of the limit current I_{LIM} the current value I_{LIM1}) in a low level period of the signal S_{PRETSD}. The switching control circuit 10 sets a current value I_{LIM2} for the limit current I_{LIM} (that is, makes the value of the limit current I_{LIM} the current value I_{LIM2}) in a high level period of the signal S_{PRETSD}. Here, the current value I_{LIM2} is smaller than the current value I_{LIM1}. For example, the current value I_{LIM1} is 2 amperes (A), and the current value I_{LIM2} is 1.5 A. However, the current values I_{LIM1} and I_{LIM2} may be set as desired as long as “I_{LIM2}<I_{LIM1}” holds. In a high level period of the signal S_{TSD}, the TSD operation stops the switching control, and therefore the limit current I_{LIM} is invalid (not defined).

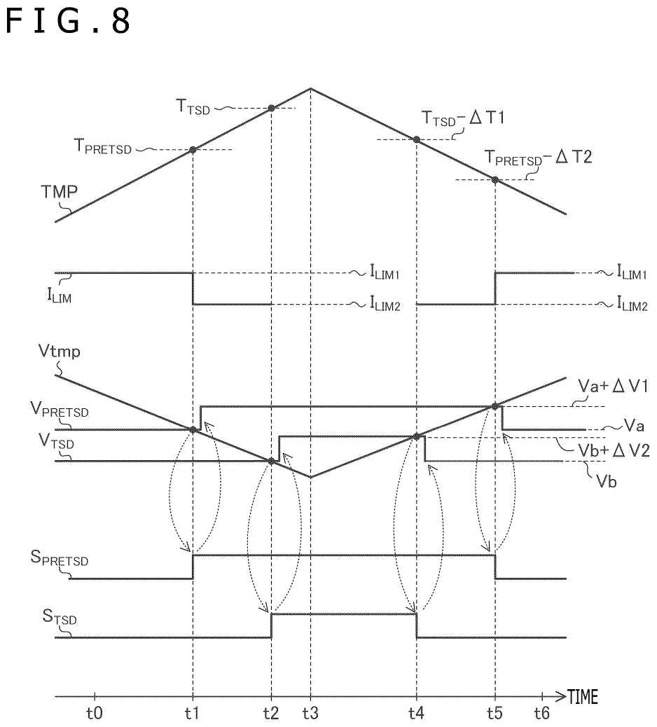

In the example illustrated in FIG. 6, the switching control circuit 10 changes the limit current I_{LIM} as follows (see also FIG. 8). In the rising process of the target temperature TMP, the switching control circuit 10 sets the current value I_{LIM1} (for example, 2 A) for the limit current I_{LIM} when the target temperature TMP is lower than the threshold temperature T_{PRETSD} (for example, 150° C.), sets the current value I_{LIM2} (for example, 1.5 A) for the limit current I_{LIM} when the target temperature TMP is higher than the threshold temperature T_{PRETSD} but lower than the threshold temperature T_{TSD} (for example, 175° C.), and performs the TSD operation that stops the switching control when the target temperature TMP reaches the threshold temperature T_{TSD} (when the target temperature TMP rises beyond the threshold temperature T_{TSD}).

After the TSD operation is performed due to the target temperature TMP exceeding the threshold temperature T_{TSD} through the rising process, the switching control circuit 10 continues the stopping of the switching control by the TSD operation when the target temperature TMP is higher than the threshold temperature (T_{TSD}−ΔT1) in the falling process of the target temperature TMP. When the target temperature TMP becomes lower than the threshold temperature (T_{TSD}−ΔT1) in the falling process of the target temperature TMP, the switching control circuit 10 sets the TSD operation in a non-executed state, and resumes the switching control of the output stage circuit MM. In an execution period of the resumed switching control, the switching control circuit 10 sets the current value I_{LIM2} (for example, 1.5 A) for the limit current I_{LIM} when the target temperature TMP is lower than the threshold temperature (T_{TSD}−ΔT1) but higher than the threshold temperature (T_{PRETSD}−ΔT2), and sets the current value I_{LIM1} (for example, 2 A) for the limit current I_{LIM} when the target temperature TMP decreases below the threshold temperature (T_{PRETSD}−ΔT2).

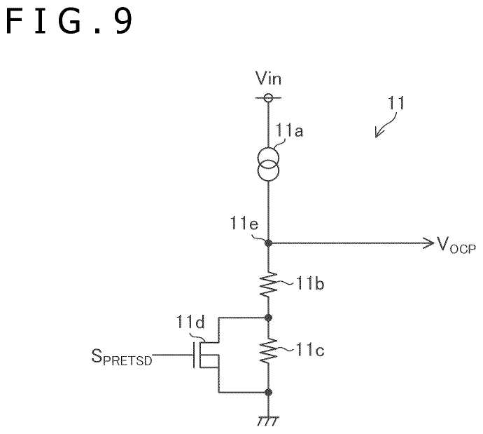

FIG. 9 illustrates a protection level setting circuit 11 as a circuit for changing the value of the limit current I_{LIM} in two steps. The protection level setting circuit 11 is provided to the switching control circuit 10. The protection level setting circuit 11 may be recognized as being provided outside the switching control circuit 10. The protection level setting circuit 11 includes a constant-current source 11a, a resistance 11b, a resistance 11c, and a transistor 11d. The transistor 11d is an N-channel MOSFET.

The constant-current source 11a operates based on the input voltage Vin, and supplies a constant current from an application terminal of the input voltage Vin to a node 11e. A first end of the resistance 11b is connected to the node 11e. A second end of the resistance 11b is connected to a first end of the resistance 11c and a drain of the transistor 11d. A second end of the resistance 11c and a source of the transistor 11d are connected to the ground. That is, the transistor 11d is connected in parallel with the resistance 11c. The signal S_{PRETSD} is input to a gate of the transistor 11d.

A voltage at the node 11e will be referred to as a voltage V_{OCP}. The transistor 11d is off in a low level period of the signal S_{PRETSD}. In the off period of the transistor 11d, the constant current from the constant-current source 11a flows through the resistances 11b and 11c to the ground, and a sum of voltage drops occurring across the resistances 11b and 11c is the voltage V_{OCP}. The transistor 11d is on in a high level period of the signal S_{PRETSD}. In the on period of the transistor 11d, the constant current from the constant-current source 11a flows through the resistance 11b and a channel of the transistor 11d to the ground, and a sum of voltage drops occurring across the resistance 11b and an on resistance of the transistor 11d is the voltage V_{OCP}. Here, the value of the on resistance of the transistor 11d is much lower than the value of the resistance 11c, and can be deemed to be zero. Hence, the voltage V_{OCP} in the high level period of the signal S_{PRETSD} is lower than the voltage V_{OCP} in the low level period of the signal S_{PRETSD}.

The switching control circuit 10 compares a comparative voltage (for example, a voltage (Vin−Vsw)) proportional to the coil current IL with the voltage V_{OCP} in an on period of the transistor MH, and generates a rise edge in the overcurrent protection signal S_{OCP} when detecting that the former voltage has risen to the voltage V_{OCP}. In response to the rise edge in the overcurrent protection signal S_{OCP}, the overcurrent protecting operation switches the output stage circuit MM from the output high state to the output low state. The current value I_{LIM1} corresponds to a current converted value of the voltage V_{OCP} in the low level period of the signal S_{PRETSD}. The current value I_{LIM2} corresponds to a current converted value of the voltage V_{OCP} in the high level period of the signal S_{PRETSD}. That is, the above-described comparative voltage (for example, the voltage (Vin−Vsw)) to be compared with the voltage V_{OCP} coincides with the voltage V_{OCP} in the low level period of the signal S_{PRETSD} when the coil current IL has the current value I_{LIM1}, and coincides with the voltage V_{OCP} in the high level period of the signal S_{PRETSD} when the coil current IL has the current value I_{LIM2}.

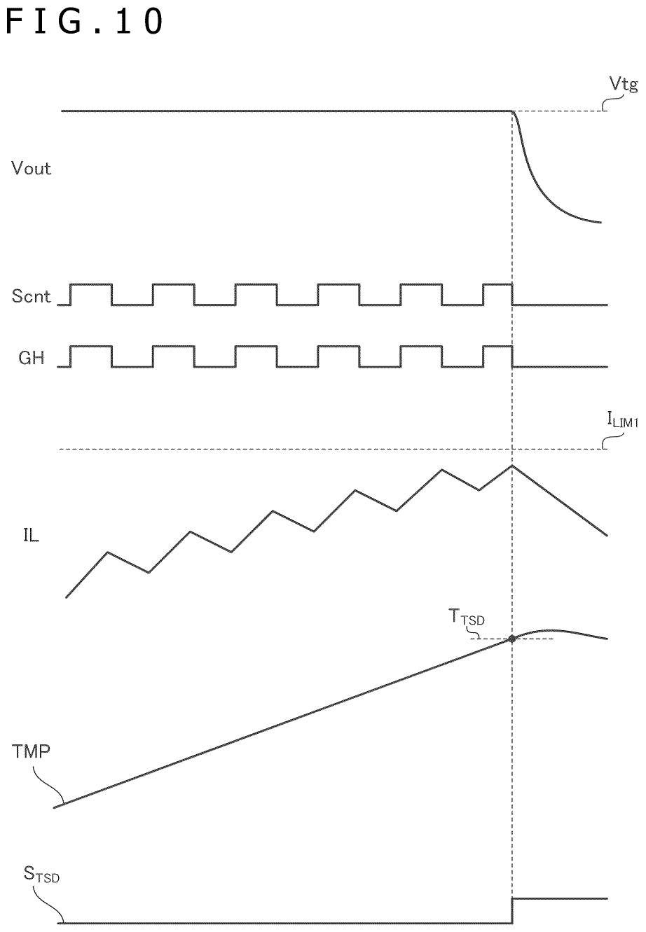

FIG. 10 illustrates a reference timing diagram of a reference power supply device. In the reference power supply device, unlike the power supply device 1, the value of the limit current I_{LIM} is fixed at the current value I_{LIM1} at all times. With regard to the reference timing diagram of the reference power supply device, an average value of the coil current IL increases in a state in which the output voltage Vout is held at or in the vicinity of the target voltage Vtg, and the target temperature TMP rises in such a manner as to be interlocked with this increase. Further, in the reference timing diagram of FIG. 10, the switching control is stopped when the target temperature TMP reaches the threshold temperature T_{TSD} without the coil current IL reaching the limit current I_{LIM} (=I_{LIM1}), and the output voltage Vout rapidly decreases to 0 V. Incidentally, the average value of the coil current IL refers to an average value of the coil current IL in each switching cycle of the output stage circuit MM.

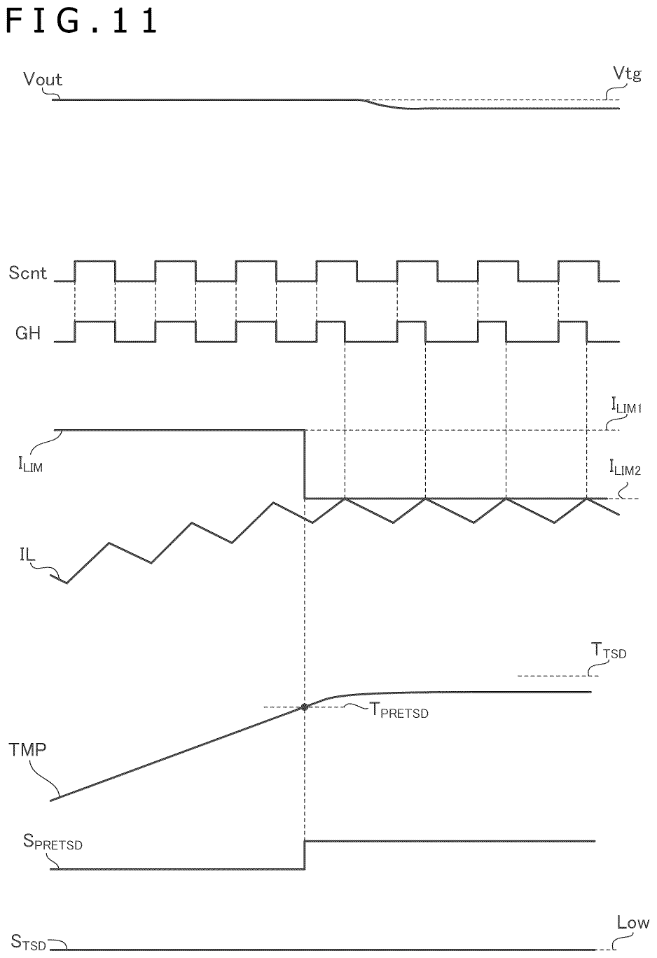

FIG. 11 illustrates a timing diagram of the power supply device 1. With regard to the timing diagram of FIG. 11, the average value of the coil current IL increases in a state in which the output voltage Vout is held at or in the vicinity of the target voltage Vtg, and the target temperature TMP rises in such a manner as to be interlocked with this increase. The value of the limit current I_{LIM} is decreased from the current value I_{LIM1} to the current value I_{LIM2} when the target temperature TMP reaches the threshold temperature T_{PRETSD} in a rising process. As a result of this, the overcurrent protecting operation is readily exerted. In the example of FIG. 11, after the value of the limit current I_{LIM} is decreased from the current value I_{LIM1} to the current value I_{LIM2}, the coil current IL (drain current of the transistor MH in the on period of the transistor MH) reaches the limit current I_{LIM} (=I_{LIM2}) in each switching cycle. The output stage circuit MM is thereby switched from the output high state to the output low state irrespective of the switching control signal Scnt. Therefore, in comparison with the reference timing diagram of FIG. 10, an amount of heat generation occurring in the output stage circuit MM is reduced, and the target temperature TMP falls within such a temperature range as not to reach the threshold temperature T_{TSD}. As a result, a rapid decrease in the output voltage Vout caused by the TSD operation is avoided.

However, in a period in which the overcurrent protecting operation is performed repeatedly, the output voltage Vout can be somewhat lower than the target voltage Vtg by an amount corresponding to a decrease in the output duty of the output stage circuit MM from the duty according to the switching control signal Scnt. When a circuit that monitors the output voltage Vout is provided to the power supply device 1, a rise in the temperature of the power supply control device 2 (“TMP>T_{PRETSD}”) can be recognized through detection of a decrease in the output voltage Vout. The power supply control device 2 may be provided with an output monitoring circuit (not illustrated) that detects whether the output voltage Vout is normal, based on the feedback voltage Vfb, and may be provided with a power-good terminal (not illustrated) as one of the external terminals. The output monitoring circuit outputs, from the power-good terminal, an error signal that becomes active based on the feedback voltage Vfb when an error between the output voltage Vout and the target voltage Vtg becomes a certain amount or more. A processor or other member connected to the power-good terminal receives the active error signal, and can thereby recognize that the output voltage Vout is abnormal and that there is a possibility that the temperature of the power supply control device 2 has risen (there is a possibility that “TMP>T_{PRETSD}”).

FIG. 12 illustrates a configuration of an internal linear regulator 31. The internal linear regulator 31 is provided to the internal power supply circuit 30 (see FIG. 1), and generates the internal power supply voltage Vreg by stepping down the input voltage Vin. The internal linear regulator 31 may be a low drop-out (LDP) regulator. The internal linear regulator 31 includes a transistor 31a and a gate control circuit 31b. In the configuration example of FIG. 12, the transistor 31a is a P-channel MOSFET. However, an N-channel MOSFET may be used as the transistor 31a. The transistor 31a is a transistor inserted in series between the application terminal of the input voltage Vin and the application terminal of the internal power supply voltage Vreg (inserted transistor). Specifically, a source of the transistor 31a is connected to the application terminal of the input voltage Vin, and receives the input voltage Vin. A drain of the transistor 31a is connected to the application terminal of the internal power supply voltage Vreg. That is, a voltage at the drain of the transistor 31a is the internal power supply voltage Vreg.

The gate control circuit 31b is connected to the source, the drain, and a gate of the transistor 31a. The gate control circuit 31b controls the gate potential of the transistor 31a, based on the internal power supply voltage Vreg (that is, the voltage at the drain of the transistor 31a), such that the internal power supply voltage Vreg coincides with a predetermined internal target voltage Vreg_tg. Though not particularly illustrated in the figure, a capacitor is provided between wiring to which the internal power supply voltage Vreg is applied and the ground. Each circuit (including the switching control circuit 10 and the temperature detecting circuit 20) that operates based on the internal power supply voltage Vreg draws in a current to be consumed by the circuit itself from the wiring to which the internal power supply voltage Vreg is applied.

The gate control circuit 31b operates in such a manner as to lower the gate potential of the transistor 31a in a state in which “Vreg<Vreg_tg” holds and raise the gate potential of the transistor 31a in a state in which “Vreg>Vreg_tg” holds. The lowering of the gate potential of the transistor 31a brings about a rise in the internal power supply voltage Vreg through an increase in the drain current of the transistor 31a. The raising of the gate potential of the transistor 31a brings about a fall in the internal power supply voltage Vreg through a decrease in the drain current of the transistor 31a. As a result, the internal power supply voltage Vreg is maintained at or in the vicinity of the internal target voltage Vreg_tg.

The internal linear regulator 31 is also provided with an overcurrent protecting function. That is, the gate control circuit 31b is capable of performing a second overcurrent protecting operation that limits the drain current of the transistor 31a to an upper limit current I_{UL} or less. The gate control circuit 31b can increase the drain current of the transistor 31a by lowering the gate potential of the transistor 31a. However, when the drain current of the transistor 31a increases to the upper limit current I_{UL}, the gate control circuit 31b stops lowering the gate potential of the transistor 31a and thereby limits the drain current of the transistor 31a to the upper limit current I_{UL} or less even when “Vreg<Vreg_tg.”

The input voltage Vin that exceeds an input voltage range specified in the specifications of the power supply control device 2 can be supplied to the power supply control device 2. A case where, for example, when the specifications of the power supply control device 2 specify that the input voltage Vin be equal to or lower than 48 V, the input voltage Vin is temporarily or steadily set to be 60 V will be examined. Supposing that the drain current of the transistor 31a is constant, when the input voltage Vin is 60 V, a loss occurring in the transistor 31a is increased, and the heat generation of the transistor 31a may exceed an allowable amount, as compared with a case where the input voltage Vin is 48 V. Alternatively, even when the input voltage Vin is within the range of the specifications, the current consumed by the circuits operating based on the internal power supply voltage Vreg may become excessively large due to some cause. As a result, the heat generation of the transistor 31a may exceed the allowable amount.

The gate control circuit 31b can perform the second overcurrent protecting operation such that the heat generation of the transistor 31a does not exceed the allowable amount. However, the allowable amount of the heat generation of the transistor 31a depends on an amount of heat generation occurring in the other circuits within the power supply control device 2 and the temperature of an ambient environment of the power supply control device 2. These are reflected in the target temperature TMP.

With this taken into consideration, the gate control circuit 31b adjusts the upper limit current I_{UL} according to the target temperature TMP (dynamically changes the upper limit current I_{UL}). The gate control circuit 31b preferably decreases the upper limit current I_{UL} stepwise as the target temperature TMP rises. This can suppress an excessive rise in the temperature of the internal linear regulator 31 (transistor 31a in particular), and thereby achieve protection of the internal linear regulator 31 and the power supply control device 2. Specifically, the signal S_{PRETSD} is supplied to the gate control circuit 31b, and the upper limit current I_{UL} is variably set according to the signal S_{PRETSD}.

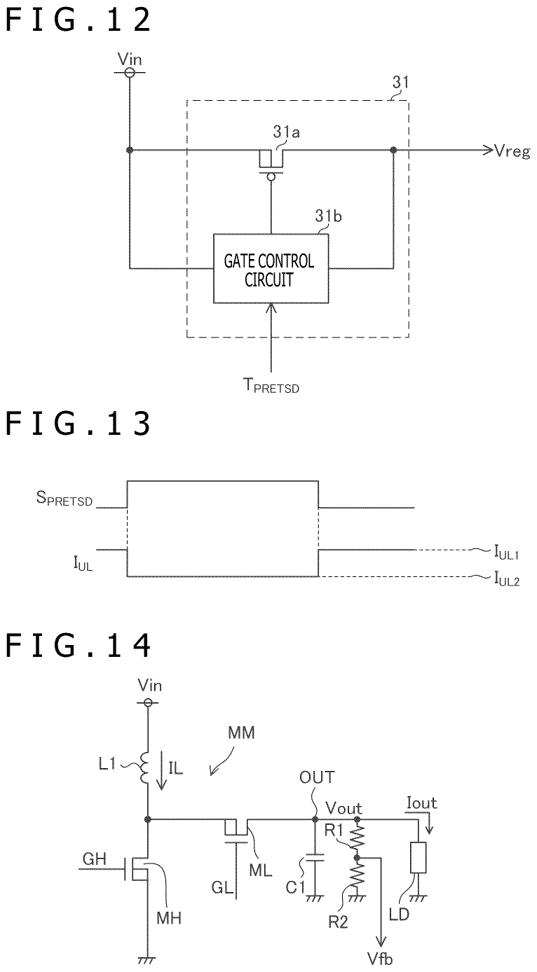

FIG. 13 illustrates a relation between the signal S_{PRETSD} and the upper limit current I_{UL}. The gate control circuit 31b sets the current value I_{UL1} for the upper limit current I_{UL} (that is, makes the value of the upper limit current I_{UL} the current value I_{UL1}) in a low level period of the signal S_{PRETSD}. The gate control circuit 31b sets the current value I_{UL2} for the upper limit current I_{UL} (that is, makes the value of the upper limit current I_{UL} the current value I_{UL2}) in a high level period of the signal S_{PRETSD}. Here, the current value I_{UL2} is smaller than the current value I_{UL1}. For example, the current value I_{UL1} is 0.1 A, and the current value I_{UL2} is 0.07 A. However, the current values I_{UL1} and I_{UL2} may be selected as desired as long as “I_{UL2}<I_{UL1}” holds.

### First Example

A first example of the power supply device 1 will be described. While a method of decreasing the limit current I_{LIM} in two steps as the target temperature TMP rises has been described above, the limit current I_{LIM} may be decreased in three steps or more as the target temperature TMP rises.

In a rising process of the target temperature TMP, for example, the switching control circuit 10 may set the value of the limit current I_{LIM} at a current value I_{LIM1} when the target temperature TMP is lower than a lower limit of a first temperature range, set the value of the limit current I_{LIM} at a current value I_{LIM2} when the target temperature TMP is within the first temperature range, set the value of the limit current I_{LIM} at a current value I_{LIM3} when the target temperature TMP is within a second temperature range, and perform the TSD operation when the target temperature TMP is higher than an upper limit of the second temperature range. Here, the second temperature range is higher than the first temperature range, and “I_{LIM1}>I_{LIM2}>I_{LIM3}” holds. Therefore, the limit current I_{LIM} is decreased in three steps as the target temperature TMP rises. The upper limit of the second temperature range corresponds to the threshold temperature T_{TSD}. The same applies t a case where the limit current I_{LIM} is decreased in a number of steps equal to or more than four steps as the target temperature TMP rises.

### Second Example

A second example of the power supply device 1 will be described. While a method of decreasing the upper limit current I_{UL} in two steps as the target temperature TMP rises has been described above, the upper limit current I_{UL} may be decreased in three steps or more as the target temperature TMP rises.

In a rising process of the target temperature TMP, for example, the gate control circuit 31b may set the value of the upper limit current I_{UL} at a current value I_{UL1} when the target temperature TMP is lower than a lower limit of a first temperature range, set the value of the upper limit current I_{UL} at a current value I_{UL2} when the target temperature TMP is within the first temperature range, and set the value of the upper limit current I_{UL} at a current value I_{UL3} when the target temperature TMP is within a second temperature range. Here, the second temperature range is higher than the first temperature range, and “I_{UL1}>I_{UL2}>I_{UL3}” holds. Therefore, the upper limit current I_{UL} is decreased in three steps as the target temperature TMP rises. An upper limit of the second temperature range corresponds to the threshold temperature T_{TSD}. The same applies to a case where the upper limit current I_{UL} is decreased in a number of steps equal to or more than four steps as the target temperature TMP rises.

### Third Example

A third example of the power supply device 1 will be described.

The power supply device 1 in FIG. 1 is a step-down switching power supply apparatus (switching regulator). However, the power supply device 1 may be a step-up switching power supply apparatus. The step-up switching power supply apparatus generates the output voltage Vout higher than the input voltage Vin by stepping up the input voltage Vin. FIG. 14 is a partial configuration diagram of the power supply device 1 in a case where the power supply device 1 is a step-up switching power supply apparatus. In the case where the power supply device 1 is a step-up switching power supply apparatus, as illustrated in FIG. 14, the first end of the coil L1 is connected to the application terminal of the input voltage Vin (terminal to which the input voltage Vin is applied), the second end of the coil L1 is connected to the drain of the transistor MH and the source of the transistor ML, the source of the transistor MH is connected to the ground, and the drain of the transistor ML is connected to the output terminal OUT, and is connected to the ground via the output capacitor C1. Further, the switching control circuit 10 performs the switching control of the output stage circuit MM such that the feedback voltage Vfb coincides with the reference voltage Vref (transistors MH and ML are alternately turned on and off). Incidentally, in the configuration of FIG. 14, the transistor ML as the rectifying element may be replaced with a synchronous rectifier diode that has an anode connected to the drain of the transistor MH and a cathode connected to the output terminal OUT. In either case, the output voltage Vout is generated based on the current (IL) flowing through the coil L1 by switching the output transistor (MH) between on and off in the switching control of the output stage circuit MM. The power supply device 1 may be a step-up/down switching power supply apparatus.

The power supply device 1 can be mounted in any electric apparatus. The electric apparatus may be an electric apparatus mounted in a vehicle such as an automobile, may be a computer device, or may be a household electric appliance or an industrial apparatus.

With regard to any signal or voltage, the relation between the high level and the low level thereof can be opposite to the foregoing in a form that does not impair the above-described spirit.

The types of channels of the FETs illustrated in the foregoing embodiment are illustrative. The type of channel of any freely-selected FET can be changed between the P-channel type and the N-channel type in a form that does not impair the above-described spirit.

Unless an inconvenience occurs, the above-described freely-selected transistor may be a transistor of any type. For example, the freely-selected transistor described above as a MOSFET can be replaced with a junction FET, an insulated gate bipolar transistor (IGBT), or a bipolar transistor unless an inconvenience occurs. The freely-selected transistor has a first electrode, a second electrode, and a control electrode. In a FET, one of the first and second electrodes is a drain, the other is a source, and the control electrode is a gate. In an IGBT, one of the first and second electrodes is a collector, the other is an emitter, and the control electrode is a gate. In a bipolar transistor not belonging to the IGBT, one of the first and second electrodes is a collector, the other is an emitter, and the control electrode is a base.

The embodiments of the present disclosure can be modified in various manners as appropriate within the scope of technical ideas illustrated in claims. The above embodiments are merely an example of embodiments of the present disclosure, and the meanings of terms of the present disclosure or respective constituent elements are not limited to those described in the above embodiments. Specific numerical values illustrated in the foregoing description are merely illustrative, and the numerical values can of course be changed to various numerical values.

### Supplementary Notes

Supplementary notes will be provided for the present disclosure whose specific configuration examples have been illustrated in the foregoing embodiments.

according to one example of the present disclosure is a power supply control device (2) provided in a switching power supply apparatus (1) configured to convert an input voltage (Vin) into an output voltage (Vout) through switching of an output transistor (MH), the switching power supply apparatus (1) including a switching control circuit (10) configured to stabilize the output voltage by performing switching control of the output transistor, based on a feedback voltage (Vfb) corresponding to the output voltage, and a temperature detecting circuit (20) configured to detect a target temperature (TMP) within the power supply control device and output a signal (Stmp, S_{PRETSD}, S_{TSD}) indicating a result of the detection of the target temperature to the switching control circuit, the switching control circuit being configured to be capable of performing an overcurrent protecting operation that limits a current flowing through the output transistor to a limit current (I_{LIM}) or less, and the switching control circuit adjusting the limit current according to the target temperature (first configuration).

Thus, the target temperature is prevented from easily rising to such a level as to necessitate the stopping of the switching control. As a result, an adverse effect accompanying the stopping of the switching control does not occur easily. This contributes to stable operation of the subsequent stage circuits.

In the power supply control device according to the foregoing first configuration, the switching control circuit may decrease the limit current stepwise as the target temperature rises (second configuration).

In the power supply control device according to the foregoing second configuration, in a rising process of the target temperature, the switching control circuit may set a first current value (I_{LIM1}) for the limit current when the target temperature is lower than a predetermined first threshold temperature (T_{PRETSD}), set a second current value (I_{LIM2}) smaller than the first current value for the limit current when the target temperature is higher than the first threshold temperature but lower than a predetermined second threshold temperature (T_{TSD}), and perform a thermal shutdown operation that stops the switching control when the target temperature is higher than the second threshold temperature (third configuration).

The target temperature is prevented from easily rising to such a level as to necessitate the stopping of the switching control by a relatively small second current value being set as the limit current when the target temperature is higher than the first threshold temperature but lower than the second threshold temperature. As a result, an adverse effect accompanying the stopping of the switching control does not occur easily. This contributes to stable operation of the subsequent stage circuits.

In the power supply control device according to the foregoing third configuration, in the rising process of the target temperature, the signal (S_{PRETSD}, S_{TSD}) output from the temperature detecting circuit to the switching control circuit may indicate a level relation between the target temperature and the first threshold temperature and a level relation between the target temperature and the second threshold temperature (fourth configuration).

In the power supply control device according to the foregoing third or fourth configuration, after performing the thermal shutdown operation when the target temperature exceeds the second threshold temperature through a rise in the target temperature, in a falling process of the target temperature, the switching control circuit may continue stopping the switching control when the target temperature is higher than a predetermined third threshold temperature (T_{TSD}−ΔT1), set the second current value for the limit current when the target temperature is lower than the third threshold temperature but higher than a predetermined fourth threshold temperature (T_{PRETSD}−ΔT2), and set the first current value for the limit current when the target temperature is lower than the fourth threshold temperature (fifth configuration).

In the power supply control device according to the foregoing fifth configuration, in the falling process of the target temperature, the signal (S_{PRETSD}, S_{TSD}) output from the temperature detecting circuit to the switching control circuit may indicate a level relation between the target temperature and the third threshold temperature and a level relation between the target temperature and the fourth threshold temperature (sixth configuration).

In the power supply control device according to any one of the foregoing first to sixth configurations, the switching control circuit may alternately turn on and off the output transistor in the switching control, and switch the output transistor to off by the overcurrent protecting operation when the current flowing through the output transistor reaches the limit current in a state in which the output transistor is controlled to be on in the switching control (seventh configuration).

according to any one of the foregoing first to seventh configurations may include an internal linear regulator (31) configured to generate an internal power supply voltage (Vreg) by stepping down the input voltage, the internal linear regulator adjusts the internal power supply voltage by controlling a gate potential of an inserted transistor (31a) inserted in series between an application terminal of the input voltage and an application terminal of the internal power supply voltage, the internal linear regulator is configured to be capable of performing another overcurrent protecting operation that limits a current flowing through the inserted transistor to an upper limit current (I_{UL}) or less, and the internal linear regulator adjusts the upper limit current according to the target temperature (eighth configuration).

It is thereby possible to, for example, suppress an excessive rise in the temperature of the internal linear regulator.

In the power supply control device according to the foregoing eighth configuration, the internal linear regulator may decrease the upper limit current stepwise as the target temperature rises (ninth configuration).

It is thereby possible to suppress an excessive rise in the temperature of the internal linear regulator.

In the power supply control device according to any one of the foregoing first to ninth configurations, the temperature detecting circuit may detect the target temperature by using a temperature measuring element (21) having an electrical characteristic that changes according to the target temperature (tenth configuration).

The present disclosure contains subject matter related to that disclosed in Japanese Priority Patent Application JP 2024-140814 filed in the Japan Patent Office on Aug. 22, 2024, the entire content of which is hereby incorporated by reference.

What is claimed is:

1. A power supply control device provided in a switching power supply apparatus configured to convert an input voltage into an output voltage through switching of an output transistor, the power supply control device comprising:
a switching control circuit configured to stabilize the output voltage by performing switching control of the output transistor, based on a feedback voltage corresponding to the output voltage; and
a temperature detecting circuit configured to detect a target temperature within the power supply control device and output a signal indicating a result of the detection of the target temperature to the switching control circuit,
the switching control circuit being configured to be capable of performing an overcurrent protecting operation that limits a current flowing through the output transistor to a limit current or less, and
the switching control circuit adjusting the limit current according to the target temperature.

2. The power supply control device according to claim 1, wherein
the switching control circuit decreases the limit current stepwise as the target temperature rises.

3. The power supply control device according to claim 2, wherein,
in a rising process of the target temperature, the switching control circuit sets a first current value for the limit current when the target temperature is lower than a predetermined first threshold temperature, sets a second current value smaller than the first current value for the limit current when the target temperature is higher than the first threshold temperature but lower than a predetermined second threshold temperature, and performs a thermal shutdown operation that stops the switching control when the target temperature is higher than the second threshold temperature.

4. The power supply control device according to claim 3, wherein,
in the rising process of the target temperature, the signal output from the temperature detecting circuit to the switching control circuit indicates a level relation between the target temperature and the first threshold temperature and a level relation between the target temperature and the second threshold temperature.

5. The power supply control device according to claim 3, wherein,
after performing the thermal shutdown operation when the target temperature exceeds the second threshold temperature through a rise in the target temperature, in a falling process of the target temperature, the switching control circuit continues stopping the switching control when the target temperature is higher than a predetermined third threshold temperature, sets the second current value for the limit current when the target temperature is lower than the third threshold temperature but higher than a predetermined fourth threshold temperature, and sets the first current value for the limit current when the target temperature is lower than the fourth threshold temperature.

6. The power supply control device according to claim 5, wherein,
in the falling process of the target temperature, the signal output from the temperature detecting circuit to the switching control circuit indicates a level relation between the target temperature and the third threshold temperature and a level relation between the target temperature and the fourth threshold temperature.

7. The power supply control device according to claim 1, wherein
the switching control circuit alternately turns on and off the output transistor in the switching control, and switches the output transistor to off by the overcurrent protecting operation when the current flowing through the output transistor reaches the limit current in a state in which the output transistor is controlled to be on in the switching control.

8. The power supply control device according to claim 1, further comprising:
an internal linear regulator configured to generate an internal power supply voltage by stepping down the input voltage, wherein
the internal linear regulator adjusts the internal power supply voltage by controlling a gate potential of an inserted transistor inserted in series between an application terminal of the input voltage and an application terminal of the internal power supply voltage,
the internal linear regulator is configured to be capable of performing another overcurrent protecting operation that limits a current flowing through the inserted transistor to an upper limit current or less, and
the internal linear regulator adjusts the upper limit current according to the target temperature.

9. The power supply control device according to claim 8, wherein
the internal linear regulator decreases the upper limit current stepwise as the target temperature rises.

10. The power supply control device according to claim 1, wherein
the temperature detecting circuit detects the target temperature by using a temperature measuring element having an electrical characteristic that changes according to the target temperature.
